(19) United States
(12) Patent Application Publication
(10) Pub. No.: US 2008/0136136 A1
(43) Pub. Date: Jun. 12, 2008

(54) Control Arm, Especially Suspension Arm, for a Vehicle Wheel Suspension

(76) Inventor: Luzian Kobier, Osnabruck (DE)

Correspondence Address: MCGLEW & TUTTLE, PC, P.O. BOX 9227, SCARBOROUGH STATION, SCARBOROUGH, NY, 10510-9227, US

(21) Appl. No.: 11/815,913

(22) PCT Filed: Feb. 3, 2006
(86) PCT No.: PCT/DE06/00177

§ 371 Date: Aug. 9, 2007

(30) Foreign Application Priority Data
Feb. 23, 2005 (DE) 10 2005 008 548.2

(51) Int. Cl. B60G 7/00

(52) U.S. Cl. 280/124.134

(57) ABSTRACT

A control (oscillating) arm, especially a suspension (transverse oscillating) arm, for a motor vehicle suspension has at least two elongated hollow body components and at least one essentially plate-like hollow body component and at least one essentially plate-like connecting (assembling) element fixed to the hollow bodies. The hollow body components (1, 2) have at least one opening (4) extending in the longitudinal axis of the component for receiving one of the end areas (7) of the connecting element. The end areas (7) of the connecting element (3) are pushed into the interior space of the hollow body component (1, 2).

The present invention pertains to a control arm, especially a suspension arm, for a motor vehicle wheel suspension, comprising at least two elongated hollow body components and at least one essentially plate-like connecting element fixed to the hollow bodies.

Various embodiments of control arms for motor vehicle wheel suspensions are known according to the state of the art. They may be embodied as shell-like components, such control arms comprising, as a rule, two shell components, which are formed from sheet metal and are welded or riveted to one another at their outer edges.

In addition, control arms of the type of this class, which are described in the introduction, are known, in which two hollow body components, which are shaped, as a rule, as closed profiles, to the outer side of which a connecting plate is welded to form the entire body. The drawback of such a control arm construction is that, on the one hand, the components to be connected to one another must be manufactured with a relatively narrow tolerance in order for the overall outside dimensions of the finished control arm to have the necessary values especially in respect to necessary connections to the chassis and to the body.

Moreover, such control arms have the drawback that the geometrical moment of inertia of the overall construction can be adapted to certain general conditions only by changing the size ratios, for example, of the hollow body components, and the thickness of the connecting web.

The object of the present invention is therefore to improve a control arm of the type of this class, which is described in the introduction, such that, on the one hand, easier tolerance compensation of the components to be connected to one another can be brought about, and, moreover, it becomes possible to adapt the construction of the components to differently shaped geometrical moments of inertia.

This object is accomplished according to the present invention by the technical teaching described in the characterizing part of claim 1.

It is essential for the present invention that the hollow body components have at least one opening extending in the longitudinal axis of the component for receiving one of the end areas of the connecting element and the end area of the connecting element to be connected to a hollow body profile is pushed into the interior space of the hollow body component to attain a higher and predetermined geometrical moment of inertia.

This design according to the present invention makes possible, on the one hand, a possibly necessary tolerance compensation concerning the outside dimensions of the control arm to be manufactured by pushing the respective end areas of the connecting element into the openings of the respective hollow body components to different depths, and a significant change in the geometrical moment of inertia of the overall construction can be achieved by selecting the depth of the pushed-in end areas.

Other advantageous embodiments of the subject of the present invention appear from the features of the subclaims.

In regard to the variation of the geometrical moment of inertia, it has proved to be especially advantageous to provide the end areas of the connecting element, which are pushed into the interior space of the hollow body components with at least one bevel within the interior space. More material of the connecting element may possibly be introduced into the interior space of the hollow body components due to one or more bevels, which in turn affects the value of the geometrical moments of inertia.

The fact that hollow body components and connecting webs are welded to one another in the area of the opening of the hollow body, as a result of which closing of the hollow body components is brought about, has proved to be an advantageous connection technique for the individual parts of the control arm. The joining point is advantageously not located directly on the outer side of the components, where especially high stresses may possibly occur.

Various embodiment variants of the subject of the present invention will be explained in more detail below on the basis of the drawings attached.

In the drawings,

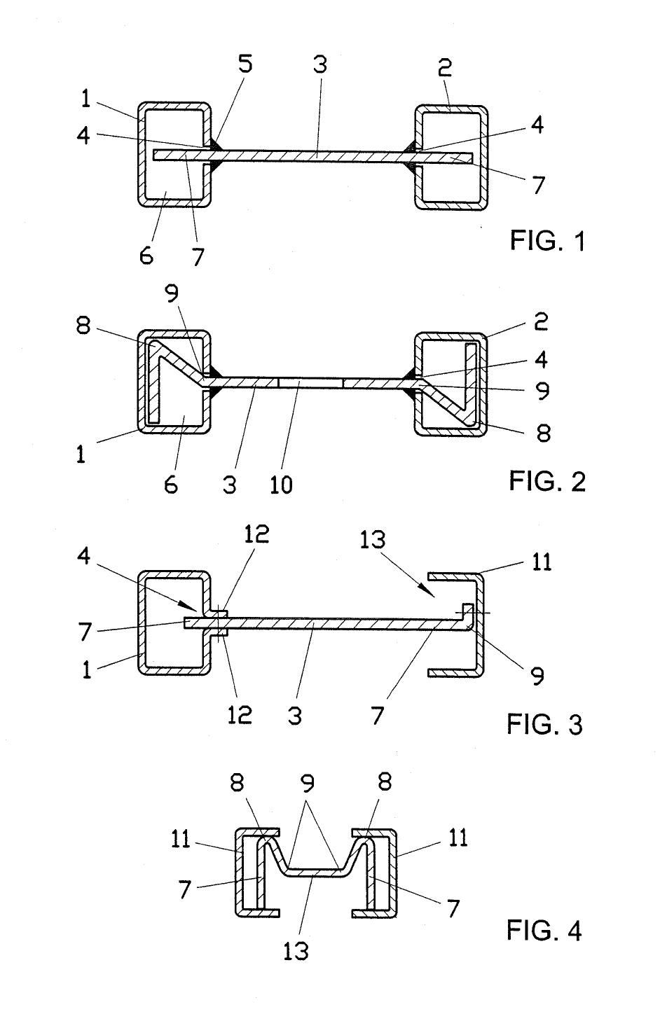

FIGS. 1 through 4 show cross-sectional view of embodiment variants of control arms according to the present invention with different dimensions.

The control arm of a motor vehicle suspension, whose cross section is shown in FIG. 1, comprises essentially a hollow body component 1, a hollow body component 2 as well as a plate-like connecting element 3 arranged between the two hollow body components 1 and 2. The hollow body components 1 and 2 have an essentially rectangular cross-sectional shape and have, on a side wall, slot-like openings 4, which are oriented in the direction of the central longitudinal axis of the hollow body components 1 and 2. The width of the openings 4 is selected to be such that it approximately corresponds to the thickness of the connecting element 3. The connecting element 3 is essentially plate-like.

FIG. 1 shows that two end areas 7 of the connecting element 3 are pushed through the openings 4 of the hollow body components 1 and 2, so that the corresponding end areas 7 are located within the interior space 6 of the hollow body components 1 and 2. This design according to the present invention has essentially two advantages. On the one hand, a certain tolerance compensation can be achieved in respect to the overall outside dimensions of the control arm by pushing in the end areas 7 of the connecting element 3. Moreover, depending on the size of the cross sections of the hollow body components 1 and 2, it may be possible to embody control arms of different sizes by pushing the end areas 7 into the interior spaces 6 of the hollow body components 1, 2 to different depths. Another favorable effect of the design is the possibility of affecting the geometrical moments of inertia of the control arm by pushing in the end areas 7. Experiments have shown that compared to a free interior space 7 of the hollow body components 1, 2, the geometrical moment of inertia of the embodiment according to FIG. 1 can be increased by about 20%. If a certain geometrical moment of inertia is required, an exactly predetermined geometrical moment of inertia can be achieved by pushing the connecting element 3 into the corresponding interior spaces 7 of the hollow body components 1, 2.

FIG. 2 shows an embodiment of a control arm for a motor vehicle wheel suspension, which again comprises, essentially analogously to FIG. 1, two hollow body components 1, 2 as well as a connecting element 3 connected to the hollow body component. The essential difference in design between the different embodiment variants can be seen in the fact that the end areas 7 of the connecting element 3, which protrude each into the interior spaces 6 of the respective components through the opening 4 within the hollow body components 1 and 2, are provided with two bevels 8 and 9 each. Due to these bevels, the weight of the end area 7 of the connecting element 3, which is arranged within the interior space 6 of the respective hollow body components 1 and 2, can be additionally increased compared to the embodiment according to FIG. 1. This leads, according to the calculations, to an increase by more than 60% in the geometrical moment of inertia compared to an empty interior space 6. The connection of the respective connecting element 3 to the hollow body components 1 and 2 is brought about by a welded connection in both embodiment variants. The welded connection is prepared, as can be seen from FIGS. 1 and 2, by means of weld seams 5, which are arranged directly adjacent to the respective opening 4 of the hollow body component 1 and 2.

The control arm shown in FIG. 3 has two hollow sections 1 and 11 of different shapes as well as a connecting element 3 arranged between them. The hollow body component 1 corresponds essentially to the embodiment as it is also seen in FIGS. 1 and 2 for the hollow body components 1 and 2 shown there. However, the hollow body component 1 according to FIG. 3 has, in the area of the opening 4, two outwardly projecting flanges 12, between which the opening gap for pushing through the end area 7 of the connecting element 3 is obtained. The shape of the opening area with the flange 12 shown may be advantageous when the hollow body component 1 shall be connected to the connecting element 3 by means of spot welding. The location of the spot welding is indicated by a dash-dotted line in FIG. 3.

The other hollow body component 11 in FIG. 3 has, contrary to the hollow body component 1, an essentially U-shaped design, so that a broader opening 13 is formed here. The end area 7 of the connecting element 3 is pushed into the opening 13 to the extent that its free end comes into contact with the rear wall of the hollow body component 11. The free end of the connecting element 3 is beveled essentially at right angles here, so that a broadening of the contact surface between the connecting element 3 and the wall of the hollow body component 11 is achieved. The two components of the suspension arm are likewise connected to one another in this area by means of a spot welding, whose location is indicated by a dash-dotted line.

FIG. 4 shows the cross section of another embodiment variant of a control arm, in which both hollow body components 11 are designed as U-shaped sections. The respective end areas 7 of the connecting element 13 are pushed into the openings obtained. These end areas are transformed in the exemplary embodiment being shown by the folds 8 and 9 such that a form that leads to a closed shape of the end areas of the control arm together with the hollow body components 11 is obtained for the connecting element 13.

### LIST OF REFERENCE NUMBERS

1 Hollow body component
2 Hollow body component
3 Connecting element
4 Opening
5 Weld seam
6 Interior space
7 End area
8 Bevel
9 Bevel
10 Opening
11 Hollow body component
12 Flange
13 Connecting element

1. A control arm for a motor vehicle wheel suspension, the control arm comprising:
at least two elongated hollow body components each having an interior space; and
at least one essentially plate-like connecting element fixed to the hollow body components, said hollow body components having at least one opening extending in a direction of a longitudinal axis of the component for receiving one of end areas of said connecting element, and that said end areas of said connecting element are pushed into the interior space of said hollow body component.

2. A control arm in accordance with claim 1, wherein said end areas of said connecting element, which are pushed into the interior space of said hollow body component, have at least one bevel within said interior space.

3. A control arm in accordance with claim 1 wherein, said hollow body component and said connecting web are welded together in the area of said opening of the hollow body.

4. A control arm in accordance with claim 1, wherein said connecting element has an opening in the partial areas not located within a interior space of a hollow body component.

5. An oscillating arm for a motor vehicle wheel suspension, the oscillating arm comprising:
a first component having a first component interior space and having a first component opening into said first component interior space, said first component opening extending in a direction of a longitudinal axis of said first component;
a second component having a second component interior space and having a second component opening into said second component interior space, said second component opening extending in a direction of a longitudinal axis of said second component; and
a plate connecting element fixed to said first component and fixed to said second component, said plate connecting element having a first end area extending into said first component interior space and having a second end area extending into said second component interior space.

6. A control arm in accordance with claim 5, wherein said first end area of said connecting element has a first bevel within said first component interior space and said second end area of said connecting element has a second bevel within said second component interior space.

7. A control arm in accordance with claim 5, wherein said connecting element is a web welded in an area of said first component opening to said first component and welded in an area of said second component opening to said second component.

8. A control arm in accordance with claim 5 wherein said connecting element has an openings between said first component and said second component.

9. A control arm in accordance with claim 5, wherein said first component and said second component each comprise a box body with parallel first and second walls joined together by parallel side walls and a side wall of said first component facing said second component defines said first component opening into said first component interior space and a side wall of said second component facing said first component defines said second component opening into said second component interior space.

10. A control arm in accordance with claim 9, wherein said connecting element is connected to said first component by a weld connection and said connecting element is connected to said second component by a weld connection.

11. A control arm in accordance with claim 5, wherein said first component and said second component each comprise a U-shaped body with parallel first and second walls joined together by a side wall and said first component opening into said first component interior space is defined between said parallel first and second walls and said second component opening into said second component interior space is defined between said parallel first and second walls.

12. A control arm in accordance with claim 11, wherein said connecting element is connected to said first component by a weld connection and said connecting element is connected to said second component by a weld connection.

13. A control arm in accordance with claim 5, wherein said first component comprises a box body with parallel first and second walls joined together by parallel side walls and a side wall of said first component facing said second component defines said first component opening into said first component interior space with a flange extending outwardly at each side of said first component opening and said second component comprises a U-shaped body with parallel first and second walls joined together by a side wall and said second component opening into said second component interior space is defined between said parallel first and second walls, said connecting element being connected to said first component by a spot weld connection and said connecting element being connected to said second component side wall by a spot weld connection.

14. A method of providing an oscillating arm for a motor vehicle wheel suspension, the oscillating arm comprising:
providing a first component having a first component interior space and having a first component opening into said first component interior space, said first component opening extending in a direction of a longitudinal axis of said first component;
providing a second component having a second component interior space and having a second component opening into said second component interior space, said second component opening extending in a direction of a longitudinal axis of said second component;
providing a plate connecting element having a first end area and having a second end area;
inserting said first end area into said first component interior space and fixing said connecting element to said first component; and
inserting said second end area into said second component interior space and fixing said connecting element to said second component wherein the depth of insertion of said first end area into said first component interior space and second end area into said second component interior space is selected to set the geometrical moments of inertia of the oscillating arm.

15. A method in accordance with claim 14, wherein said first end area of said connecting element has a first bevel within said first component interior space and said second end area of said connecting element has a second bevel within said second component interior space.

16. A method in accordance with claim 14, wherein said first component and said second component each comprise a box body with parallel first and second walls joined together by parallel side walls and a side wall of said first component facing said second component defines said first component opening into said first component interior space and a side wall of said second component facing said first component defines said second component opening into said second component interior space, wherein said connecting element is connected to said first component by a weld connection and said connecting element is connected to said second component by a weld connection.

17. A method in accordance with claim 14, wherein said first component and said second component each comprise a U-shaped body with parallel first and second walls joined together by a side wall and said first component opening into said first component interior space is defined between said parallel first and second walls and said second component opening into said second component interior space is defined between said parallel first and second walls, wherein said connecting element is connected to said first component by a weld connection and said connecting element is connected to said second component by a weld connection.

18. A method in accordance with claim 14, wherein said first component comprises a box body with parallel first and second walls joined together by parallel side walls and a side wall of said first component facing said second component defines said first component opening into said first component interior space with a flange extending outwardly at each side of said first component opening and said second component comprises a U-shaped body with parallel first and second walls joined together by a side wall and said second component opening into said second component interior space is defined between said parallel first and second walls, said connecting element being connected to said first component by a spot weld connection and said connecting element being connected to said second component side wall by a spot weld connection.
